(19) United States
(12) Patent Application Publication
(10) Pub. No.: US 2026/0094623 A1
(43) Pub. Date: Apr. 2, 2026

(54) DIFFUSION BARRIER AGAINST MIGRATION OF VOLATILE ORGANIC CONTAMINANTS INTO HARD DISK DRIVE INTERIOR

(71) Applicant: SEAGATE TECHNOLOGY LLC, Fremont, CA (US)

(72) Inventors: Paul Allison Beatty, Fort Collins, CO (US); Jackson Wagner Nichols, Belle Plaine, MN (US); Henry Kussin-Bordo, Lafayette, CO (US); Brian D. Adler, Longmont, CO (US); Akihiko Ohnaka, Longmont, CO (US); Kent J. Forbord, Minneapolis, MN (US)

(21) Appl. No.: 18/901,251

(22) Filed: Sep. 30, 2024

(51) Int. Cl. G11B 33/14

(52) U.S. Cl. CPC G11B 33/1446

(57) ABSTRACT

Disclosed are sealed-enclosure disk drives that utilize diffusion barriers to prevent volatile organic contaminants (VOCs) from migrating or flowing through interstitial spaces between covers of the disk drives, and thereby reaching the interior space where components reside that may be susceptible to VOCs. Accordingly, a diffusion barrier is disposed between the top cover and the process cover of the hard drive and positioned to reside in a migration path of VOCs to the interior space. The VOCs are primarily produced by a source of VOCs located in interstitial spaces between the covers, for example an adhesive that bonds the covers, a vibration dampener material, or the like. The diffusion barrier may include activated carbon selected to absorb and/or sequester VOCs.

This disclosure relates to sealed-enclosure hard disk drive devices.

### SUMMARY

In accordance with certain aspects, the present disclosure describes hard disk drive devices (HDDs) that include a sealed enclosure forming an interior space containing head-disk assembly (HDA) components of the hard disk drive, the sealed enclosure including a top cover sealed over an HDA cover, a source of volatile organic contaminants situated between the top cover and the HDA cover, and a diffusion barrier configured to trap volatile organic contaminants, the diffusion barrier disposed between the top cover and the HDA cover and positioned to reside in a migration path from the source of volatile organic contaminants to the interior space. The HDDs may be heat-assisted magnetic recording HDDs.

In certain aspects, the diffusion barrier includes an activated carbon. The diffusion barrier may be formed from a carbon sheet stock material, for example composed of carbon beads adhered to a mesh or fabric, or carbon particles disposed in a binder matrix. In certain aspects, the diffusion barrier is arranged in one or more abutting segments to substantially enclose the source of volatile organic contaminants from access to the migration path.

In certain aspects, the source of volatile organic contaminants is a pressure sensitive adhesive that bonds the top cover to the HDA cover. In certain aspects, the source of volatile organic contaminants is vibration dampening material.

In certain aspects, the diffusion barrier includes one or more types of carbon selected to preferentially trap one or more types of volatile organic contaminants. For example, the one or more types of volatile organic contaminants may include low molecular weight volatile organic contaminants, high molecular weight volatile organic contaminants, or polar volatile organic contaminants.

In accordance with certain aspects, the present disclosure describes HDDs that include a sealed enclosure forming an interior space containing HDA components of the HDD, the sealed enclosure including a base, an HDA cover attached to the base to thereby define the interior space between the base and the HDA cover, and a top cover sealed over the HDA cover to thereby form an interstitial space between the top cover and the HDA cover. The HDDs include a source of volatile organic contaminants situated in the interstitial space between the top cover and the HDA cover, and further include a diffusion barrier configured to trap volatile organic contaminants. The diffusion barrier is disposed in the interstitial space between the top cover and the HDA cover and is arranged to substantially close off the source of volatile organic contaminants from access to a flow path to the interior space.

In certain aspects, the HDDs further include a gasket disposed between the base and the HDA cover around a periphery of the enclosure such that the flow path includes diffusion through the gasket.

In certain aspects, the diffusion barrier is formed of an activated carbon sheet stock material. For example, the activated carbon sheet stock material may include a coconut husk-based carbon and/or a wood-based carbon.

In certain aspects, the diffusion barrier is adhesively attached to one or both of the top cover and the HDA cover.

In certain aspects, the source of volatile organic contaminants is a pressure sensitive adhesive that bonds the top cover to the HDA cover. In certain aspects, the source of volatile organic contaminants is vibration dampening material disposed between the top cover and the HDA cover and adhesively attached to at least one of the top cover and the HDA cover.

In certain aspects, the diffusion barrier is adhesively attached to at least one of the top cover and the HDA cover.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is schematic representation of a sealed-enclosure hard disk drive device for use with aspects of the present disclosure.

FIG. 2 is a schematic top view of a diffusion barrier disposed to surround a source of volatile organic contaminants in accordance with aspects of the present disclosure.

FIG. 3 is a schematic partial side view of an HDA cover and a top cover of a sealed-enclosure hard disk drive device.

### DETAILED DESCRIPTION

The present disclosure relates to the use of diffusion barriers to prevent volatile organic contaminants (VOCs) from migrating or flowing through interstitial spaces between covers in a sealed hard disk drive (HDD), and thereby reaching the interior space of the HDD where components that may be susceptible to VOCs reside. Such components include components of the head-disk assembly.

Heat-assisted magnetic recording (HAMR) HDDs may be particularly susceptible to VOCs. In HAMR HDDs, the surface of the recording media is elevated up to 500 degrees C or more during writing. Without wishing to be bound by any theory, it has been observed that organic residues present at the HAMR head-disk interface can act as optical absorbers of near-field infrared light and thereby interfere with optimal HAMR drive operations. These organic residues, also referred to as carbonaceous residues or “smear,” are believed to originate from volatile organic contaminants present in the interior of the HDD enclosure.

Certain HAMR drive enclosures are designed with covers that include two pieces. The first piece is a process cover that is screwed onto the base deck over the interior of the HDD that houses working components of the head-disk assembly (HDA), which components are involved in the recording of data to and retrieval of data from magnetic media disks using a recording head. Installing the process cover, also referred to herein as the HDA cover, may be performed during manufacturing of the HDD. The second piece is a hermetic final cover, also referred to herein as the top cover, that is welded or otherwise bonded onto the base deck (or other suitable part of the HDD housing) over the HDA cover. The installation of a top cover over an HDA cover results in the creation of interstitial spaces between the two covers. The interstitial spaces can form migration paths that allow the flow of gas-phase molecules between the covers into the interior space of the HDD enclosure.

A pressure-sensitive adhesive (PSA) may be disposed in one or more of the interstitial spaces between the top cover and HDA cover to bond the two cover pieces together. PSA materials have been found to release VOCs that can in turn diffuse through the interstitial space(s) and through the process cover gasket (if present) into the interior space of the HDD where the HDA resides. The presence of VOCs in and around the HDA can reduce reliability of the drive, particularly for HAMR HDDs. In addition, one or more vibration dampers may be disposed between the top cover and the HDA cover, and these vibration dampers are typically made of materials that can release VOCs.

To help reduce or prevent VOC migration and diffusion from sources of VOCs, such as PSAs and vibration dampers, into the HDD interior, the present disclosure describes the use of diffusion barriers positioned in the flow path of VOC migration or diffusion between the top cover and the HDA cover. In certain aspects, such diffusion barriers may be composed of activated carbon materials that effectively absorb and sequester VOCs. Such a diffusion barrier that substantially or completely surrounds the central mass of the VOC source would substantially reduce or prevent any outgassed VOCs from reaching the interior space of the HDD.

Reference will now be made to the drawings, which depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar. It will also be appreciated that the drawings are meant to illustrate certain aspects and arrangements of features in a way that contributes to their understanding, and are not meant to be scale drawings that accurately represent size or shape of elements.

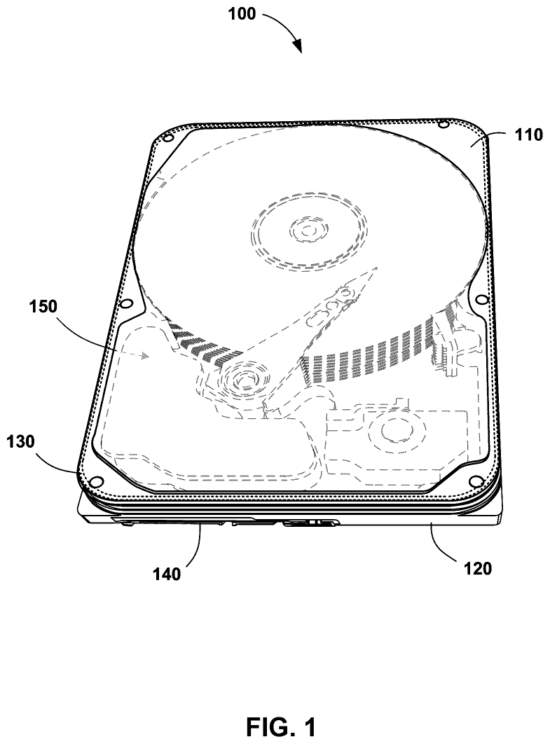

FIG. 1 schematically depicts a sealed-enclosure hard drive device 100. The enclosure includes a base 120 and a cover assembly 110. The cover assembly 110 includes an HDA cover (not separately indicated) that is attached to the base 120 and a top cover (not separately indicated) that is welded or otherwise bonded over the HDA cover to thereby form a hermetic seal. A gasket 130 may be disposed around the periphery of the cover assembly 110 and the base 120. The enclosure encloses an interior space 150 that includes operational components of the hard drive device 100, including magnetic media disks for storing data, actuator arms for positioning recording heads, motors for moving the disks and the actuator arms, controller electronics, optional environmental control modules and/or filtration devices, and so forth. The enclosure includes an interface 140 for electronically coupling the hard drive device 100 to a host device.

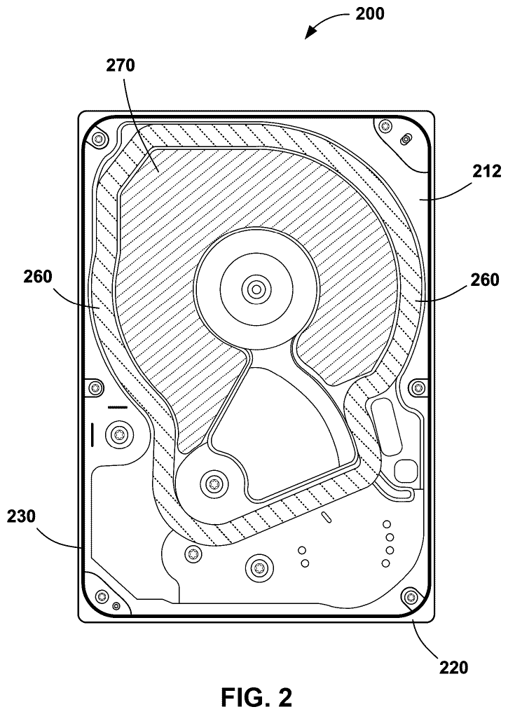

FIG. 2 shows a schematic top view of a seal-enclosure hard drive device 100 that has the top cover of the cover assembly removed, thereby exposing the HDA cover 212. HDA cover 212 is attached to base 220 with a gasket 230 disposed between them around the periphery. A vibration damper 270 is disposed on the HDA cover 212 such that vibration damper 270 will be sandwiched between the HDA cover 212 and the top cover when the top cover is installed over the HDA cover 212. Vibration damper 270 may be composed of materials that release VOCs via outgassing or another mechanism. For example, vibration damper 270 may be a constrained-layer damper formed by applying a thin sheet of two-sided PSA material to a stainless-steel sheet. Such a damper assembly may be bonded to the HDA cover 212.

A diffusion barrier 260 is disposed on the HDA cover 212 such that the diffusion barrier 260 substantially surrounds the vibration damper 270. When the top cover is sealed over the HDA cover 212, the diffusion barrier 260 substantially “encloses” the vibration damper 270 between the covers, thereby reducing or preventing the migration of any VOCs released by the material of the vibration damper 270 into interstitial spaces that lead to the interior of the hard drive device 100. For example, in the absence of diffusion barrier 260, interstitial spaces between the HDA cover 212 and the top cover may provide a flow path for VOC migration to the gasket 230. Diffusion of VOCs at the location of the gasket 230 can allow VOCs to penetrate into the interior space of the hard drive device 200.

The diffusion barrier 260 may be made of an activated carbon matrix or impregnated material, such as is commercially available in sheet form from Donaldson Company. One variety of carbon sheet is made of carbon particles in a binder matrix. Another variety is composed of carbon beads adhered to a plastic mesh or fabric. For the activated carbon, a coconut husk-based carbon may be used to preferentially absorb low molecular weight and polar VOCs, and a wood-based carbon may be used to preferentially absorb higher molecular weight VOCs. In this way, the carbon can be selected based on the types of VOCs expected to be generated in the spaces between the covers. The binder matrix carbon sheets are typically very pliable, and may be installed by directly attaching to one or both covers, for example using a thin layer of PSA. It may be preferable to include enough carbon absorber in the diffusion barrier to account for VOCs produced by the PSA that attaches the carbon sheet as well as the VOCs that are produced by other VOC sources. The carbon bead and mesh materials are typically stiffer, and thus might be installed by placing into an interstitial space between the covers without use of an adhesive.

Diffusion barrier 260 may be formed as a continuous ring, for example by die cutting a ring from activated carbon sheet stock. Alternatively, diffusion barrier 260 may be cut from sheet stock in shorter strips or segments that are assembled, for example end-to-end to form a perimeter around a VOC source. Cutting shorter segments may be a more efficient and less wasteful use of sheet material than cutting single, continuous rings or other shapes. When assembling shorter segments, small gaps between segments of the diffusion barrier 260 after installation are unlikely to degrade the performance of the diffusion barrier as compared to a complete ring.

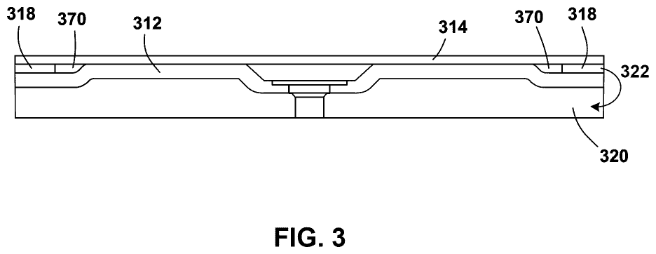

FIG. 3 schematically shows a partial cut-away side view of a portion of a hard drive enclosure that includes an HDA cover 312 attached to a base 320, and a top cover 314 sealed over the HDA cover 312 thereby producing interstitial spaces 318 between the top cover 314 and the HDA cover 312. The HDA cover 312 may be screwed to the base 320 during manufacturing, and the top cover 314 may be hermetically welded onto the base after the HDD has passed certification testing. A PSA material 370 may be disposed between the top cover 314 and the HDA cover 312 to facilitate bonding. The PSA 370 may be source of VOCs, and the interstitial spaces 318 may provide a flow path 322 for VOCs to migrate into the hard drive interior underneath the HDA cover 312. Flow path 322 may include diffusion through a gasket (not shown) between the HDA cover 312 and the base 320 around the periphery of the hard drive enclosure. As such, a diffusion barrier (not shown) may be provided between the top cover 314 and the HDA cover 312 and positioned in the interstitial space(s) 318 in a way that substantially impedes VOCs from following migration path 322 from the PSA 370 (or other VOC source) into the interior of the hard drive device.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (for example, all described acts or events may not be necessary to carry out the techniques). In addition, while certain aspects of this disclosure are described as being performed by a single module or unit for purposes of clarity, it should be understood that the techniques of this disclosure may be performed by a combination of units or modules.

All scientific and technical terms used herein have meanings commonly used in the art unless otherwise specified. The definitions provided herein are to facilitate understanding of certain terms used frequently herein and are not meant to limit the scope of the present disclosure.

As used herein, the term “configured to” may be used interchangeably with the terms “adapted to” or “structured to” unless the content of this disclosure clearly dictates otherwise.

As used herein, the term “or” refers to an inclusive definition, for example, to mean “and/or” unless its context of usage clearly dictates otherwise. The term “and/or” refers to one or all of the listed elements or a combination of at least two of the listed elements.

As used herein, the phrases “at least one of” and “one or more of” followed by a list of elements refers to one or more of any of the elements listed or any combination of one or more of the elements listed.

As used herein, the terms “coupled” or “connected” refer to at least two elements being attached to each other either directly or indirectly. An indirect coupling may include one or more other elements between the at least two elements being attached. Further, in one or more embodiments, one element “on” another element may be directly or indirectly on and may include intermediate components or layers therebetween. Either term may be modified by “operatively” and “operably,” which may be used interchangeably, to describe that the coupling or connection is configured to allow the components to interact to carry out described or otherwise known functionality. For example, a controller may be operably coupled to a resistive heating element to allow the controller to provide an electrical current to the heating element.

As used herein, any term related to position or orientation, such as “proximal,” “distal,” “end,” “outer,” “inner,” and the like, refers to a relative position and does not limit the absolute orientation of an embodiment unless its context of usage clearly dictates otherwise.

The singular forms “a,” “an,” and “the” encompass embodiments having plural referents unless its context clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

What is claimed is:

1. A hard disk drive device comprising:
a sealed enclosure forming an interior space containing HDA components of the hard disk drive, the sealed enclosure including a top cover sealed over an HDA cover;
a source of volatile organic contaminants situated between the top cover and the HDA cover; and
a diffusion barrier configured to trap volatile organic contaminants, the diffusion barrier disposed between the top cover and the HDA cover and positioned to reside in a migration path from the source of volatile organic contaminants to the interior space.

2. The hard disk drive device of claim 1, wherein the diffusion barrier comprises activated carbon.

3. The hard disk drive device of claim 1, wherein the source of volatile organic contaminants is a pressure sensitive adhesive that bonds the top cover to the HDA cover.

4. The hard disk drive device of claim 1, wherein the source of volatile organic contaminants is vibration dampening material.

5. The hard disk drive device of claim 1, wherein the diffusion barrier is arranged in one or more abutting segments to substantially enclose the source of volatile organic contaminants from access to the migration path.

6. The hard disk drive device of claim 1, wherein the diffusion barrier is formed from a carbon sheet stock material.

7. The hard disk drive device of claim 1, wherein the diffusion barrier comprises carbon particles disposed in a binder matrix.

8. The hard disk drive device of claim 1, wherein the diffusion barrier comprises carbon beads adhered to a mesh or fabric.

9. The hard disk drive device of claim 1, wherein the diffusion barrier comprises one or more types of carbon selected to preferentially trap one or more types of volatile organic contaminants.

10. The hard disk drive device of claim 9, wherein the one or more types of volatile organic contaminants include low molecular weight volatile organic contaminants, high molecular weight volatile organic contaminants, or polar volatile organic contaminants.

11. The hard disk drive device of claim 1, wherein the hard disk drive is a HAMR drive.

12. A hard disk drive device comprising:
a sealed enclosure forming an interior space containing HDA components of the hard disk drive, the sealed enclosure including a base, an HDA cover attached to the base to thereby define the interior space between the base and the HDA cover, and a top cover sealed over the HDA cover to thereby form an interstitial space between the top cover and the HDA cover;
a source of volatile organic contaminants situated in the interstitial space between the top cover and the HDA cover; and
a diffusion barrier configured to trap volatile organic contaminants, the diffusion barrier disposed in the interstitial space between the top cover and the HDA cover and arranged to substantially close off the source of volatile organic contaminants from access to a flow path to the interior space.

13. The hard disk drive device of claim 12, wherein the hard disk drive is a HAMR drive.

14. The hard disk drive device of claim 12, further comprising a gasket disposed between the base and the HDA cover around a periphery of the enclosure, and wherein the flow path includes diffusion through the gasket.

15. The hard disk drive device of claim 12, wherein the diffusion barrier is formed of an activated carbon sheet stock material.

16. The hard disk drive device of claim 15, wherein the activated carbon sheet stock material includes a coconut husk-based carbon and/or a wood-based carbon.

17. The hard disk drive device of claim 12, wherein the diffusion barrier is adhesively attached to one or both of the top cover and the HDA cover.

18. The hard disk drive device of claim 12, wherein the source of volatile organic contaminants is a pressure sensitive adhesive that bonds the top cover to the HDA cover.

19. The hard disk drive device of claim 12, wherein the source of volatile organic contaminants is vibration dampening material disposed between the top cover and the HDA cover and adhesively attached to at least one of the top cover and the HDA cover.

20. The hard disk drive device of claim 12, wherein the diffusion barrier is adhesively attached to at least one of the top cover and the HDA cover.
